(19) United States
(12) Patent Application Publication
(10) Pub. No.: US 2025/0068984 A1
(43) Pub. Date: Feb. 27, 2025

(54) METHOD FOR FAILURE WARNING OF STORAGE DEVICE AND STORAGE DEVICE

(71) Applicant: Samsung Electronics Co., Ltd., Suwon-si (KR)

(72) Inventors: Yuqi ZHANG, Xian (CN); Shuyang WANG, Xian (CN); Wenwen HAO, Xian (CN); Yongwong KWON, Suwon-si (KR); Chankyu KOH, Suwon-si (KR)

(73) Assignee: Samsung Electronics Co., Ltd., Suwon-si (KR)

(21) Appl. No.: 18/584,140

(22) Filed: Feb. 22, 2024

(30) Foreign Application Priority Data
Aug. 25, 2023 (CN) 202311085480.1

(51) Int. Cl. G06N 20/20

(52) U.S. Cl. CPC G06N 20/20

(57) ABSTRACT

A method for operating a storage device and the storage device are provided. The method includes obtaining an initial failure warning model comprising a plurality of decision trees, the obtaining the initial failure warning model including being trained with a random forest algorithm based on historical failure related data, the historical failure related data comprising historical multiple operational attributes data of the storage device and failure logs of the storage device, determining high frequency decision nodes in the plurality of decision trees, the high frequency decision nodes being similar single-nodes with at least a first number in the plurality of decision trees, the similar single-nodes being single-nodes having a same monitoring attribute, a same attribute determination symbol, and a difference between attribute thresholds within a first range, and constructing the failure warning model of a new decision tree comprising the high frequency decision nodes.

### CROSS-REFERENCE TO RELATED APPLICATIONS

This application is based on and claims priority under 35 U.S.C. § 119 to Chinese Patent Application No. 202311085480.1, filed on Aug. 25, 2023, in the China National Intellectual Property Administration, the contents of which are incorporated by reference herein in their entirety.

### BACKGROUND

Various example embodiments relate to the field of data storage, and more particularly, to a method for failure warning of a storage device and the storage device.

With the development of storage technology, there is a growing demand for reliability of storage devices, especially solid state drives (SSDs), and various storage device warning systems have been developed, for example, a centralized monitoring and warning system and/or an SSD self-warning system. By monitoring and recording operation situations of storage devices, and by comparing the operation situations with preset safety values, the storage device warning systems may warn users to secure hard drive data in advance.

The centralized monitoring and warning system may include centralized monitoring and warning solutions that are relatively expensive to deploy, operate, and/or maintain (e.g., updates to monitoring attributes require updates to collection tools, databases, etc.). The centralized monitoring and warning system may also have undetectable failure or an untimely warning caused by networks, databases, and collection tools, real data collected from a customer data center has problems with data loss, a long collection interval, and/or a serial number (SN) error. The SSD self-warning system may include judgment for a single attribute threshold, which may detect a limited type of failure, and the preset threshold that may be strict, which may cause the failure that may not be discovered in time. The warning rules may be fixed and may not be updated during the use of SSDs.

### SUMMARY

Various example embodiments may provide a method for failure warning of a storage device and the storage device to solve or at least improve upon at least the problem of low warning capability of related technology.

According to various example embodiments, a method for operating a storage device is provided, including obtaining an initial failure warning model comprising a plurality of decision trees, the obtaining the initial failure warning model including being trained with a random forest algorithm based on historical failure related data, the historical failure related data comprising historical multiple operational attributes data of the storage device and failure logs of the storage device, determining high frequency decision nodes in the plurality of decision trees, the high frequency decision nodes being similar single-nodes with at least a first number in the plurality of decision trees, the similar single-nodes being single-nodes having a same monitoring attribute, a same attribute determination symbol, and a difference between attribute thresholds within a first range, and constructing a failure warning model of a new decision tree comprising the high frequency decision nodes.

Alternatively or additionally according to various example embodiments, a device for constructing a failure warning model of a storage device is provided, the device comprising a model training module configured to obtain an initial failure warning model that includes a plurality of decision trees, the obtaining the initial failure warning model including being trained with a random forest algorithm based on historical failure related data, the historical failure related data comprising historical multiple operational attributes data of the storage device and failure logs of the storage device, a decision node determination module configured to determine high frequency decision nodes in the plurality of decision trees, the high frequency decision nodes being similar single-nodes with at least a number in the plurality of decision trees, the similar single-nodes being single-nodes having a same monitoring attribute, a same attribute determination symbol, and difference between attribute thresholds within a first range, and a model construction module configured to construct the failure warning model of a new decision tree that includes the high frequency decision nodes.

The technical solutions provided according to various example embodiments bring about or help to bring about at least the following beneficial effects: a more accurate and more comprehensive decision tree based failure warning model extracted or trained by analyzing failure related data through statistical methods and/or machine learning methods. Alternatively or additionally, the judgment overhead is very small due to the simplification of the random forest and decision tree models, which are mainly based on the threshold judgment for several attributes. Alternatively or additionally by continuously collecting failure related data to optimize or improve upon and update the model, and updating the warning model into the storage device through command parameters or a configuration file, the decision tree failure warning model with joint judgment for multiple attributes may make increasingly accurate and/or timely failure warnings through the improvement and updating. Alternatively or additionally, construction of the failure warning model is completed outside the storage device, and then the constructed simplified model is imported into the storage device, which may take into account problems of limited computing power of the firmware and may facilitate the deployment of the model in the storage device.

It should be understood that the above general description and the later detailed description are explanatory only and are not for limitation.

### BRIEF DESCRIPTION OF THE DRAWINGS

The accompanying drawings herein are incorporated into and form part of the specification, illustrate example embodiments consistent with the disclosure, which are used in conjunction with the specification to explain the principles of the disclosure and do not constitute an undue limitation of the disclosure.

FIG. 1 illustrates a schematic diagram of a failure warning system of a storage device according to various example embodiments.

FIG. 2 illustrates a flowchart of a method for constructing a failure warning model of a storage device according to various example embodiments.

FIG. 3 illustrates a schematic diagram of simplifying a decision tree based failure warning model according to various example embodiments.

FIG. 4 illustrates a flowchart of a method for failure warning of a storage device according to various example embodiments.

FIG. 5 illustrates a schematic diagram of import/update of a failure warning model into a storage device according to various example embodiments.

FIG. 6 illustrates an overall flowchart of a method for failure warning of a storage device according to various example embodiments.

FIG. 7 illustrates a schematic diagram of a device for constructing a failure warning model of a storage device according to various example embodiments.

FIG. 8 illustrates a schematic diagram of a storage device according to various example embodiments.

FIG. 9 is a diagram of a system 1000 to which a storage device is applied according to various example embodiments.

FIG. 10 is a block diagram of a host storage system 10 according to various example embodiments.

FIG. 11 is a diagram of a data center 3000 to which a memory device is applied according to some example embodiments.

### DETAILED DESCRIPTION

In order to enable a person of ordinary skill in the art to better understand some technical solutions, technical solutions provide by example embodiments will be clearly and completely described below in conjunction with the accompanying drawings.

It should be noted that the terms “first”, “second”, etc. in the specification and claims of the disclosure and the accompanying drawings above are used to distinguish similar objects rather than to describe a particular order or sequence. It should be understood that data so distinguished may be interchanged, where appropriate, so that example embodiments described herein may be implemented in an order other than those illustrated or described herein. Embodiments described in the following examples do not represent all embodiments that are consistent with the disclosure. Rather, they are only examples of devices and methods that are consistent with some aspects of the disclosure, as detailed in the appended claims.

It should be noted herein that “at least one of the several items” in this disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of step one and step two”, which may mean the following three juxtapositions (1) performing step one; (2) performing step two; (3) performing step one and step two.

Storage device warning systems include or are included in, for example, a centralized monitoring and warning system and/or an SSD self-warning system. The centralized monitoring and warning system regularly collects monitoring data of a storage device and uploads the monitoring data to a database, and regularly performs storage device failure warning through various rules and/or classifications according to the monitoring data. As for the SSD self-warning system, an SSD may perform self-warning based on the monitoring data, and the warning rules may generally be based on the threshold judgment for a single monitoring attribute. Problems with the centralized monitoring and warning system may lie in that centralized monitoring and warning solutions are expensive to deploy, operate and maintain; due to problems with one or more of networks, databases, and collection tools, real data collected from a customer data center has the problems with data loss, a long collection interval, and a SN error, resulting in a large number of undetectable failure undetectable or a untimely warning. Problems with the SSD self-warning system may lie in that judgment for a single attribute threshold may only detect a certain type of failure, and the preset threshold is strict which may cause that the failure cannot be discovered in time; the warning rules are fixed and may not be optimized and customized during the use of SSDs, while there are more and more customized monitoring attributes, which may be configured for constant updating of the warning rules.

To solve or help improve upon the above problems, example embodiments may provide a method for failure warning of a storage device and the storage device. In a first aspect, a decision tree based failure warning model is constructed. A more accurate and/or comprehensive decision tree failure warning model may be extracted and trained by analyzing failure related data through analytical traversal methods or machine learning methods. Meanwhile, compared with single attribute self-warning, a multi-attribute decision tree failure warning model may introduce read/write related attributes to adapt to different workloads, and thus has a higher generalizability. Alternatively or additionally, the constructed decision tree failure warning model may be applied to more customers (e.g., customers without large-scale monitoring), and, since there is no centralized data collection, there are no or there are likely to be a reduced number of problems such as a long collection interval and data loss during collection. Alternatively or additionally, the decision tree based failure warning model is simplified, and its judgment overhead is very small due to the simplification of the decision tree, which may mainly be based on the threshold judgment for several attributes. Alternatively or additionally, the model is improved upon or optimized and updated by continuously collected failure related data, and the warning model is updated into the storage device through command parameters or a configuration file. Through improvement or optimization and updating, the decision tree failure warning model with joint judgment for multi-attribute may make increasingly accurate and timely failure warning. Alternatively or additionally, construction of the failure warning model is completed outside the storage device, and then the constructed simplified model is imported into the storage device, which fully or is more likely to fully take into account the problem of limited computing power of the firmware and facilitates the deployment of the model in the storage device.

The method of failure warning as used in various example embodiments may be applied to a storage device with self-monitoring and warning functions. Hereinafter, the method for failure warning of the storage device and the storage device according to the disclosure are described specifically with reference to FIGS. 1 to 11.

FIG. 1 illustrates a schematic diagram of a failure warning system of a storage device according to various example embodiments.

Referring to FIG. 1, a failure warning system 100 of the storage device may include a warning model construction module 110 and an updatable warning model based warning module 120. The warning module 120 may be deployed in the storage device (e.g., a solid state drive SSD) and being part of the storage device (an operation of the warning module 120 may be considered as an operation of the storage device), for example, the warning module 120 may be deployed in the firmware of the storage device. In FIG. 1, the warning model construction module 110 constructs a decision tree based failure warning model by mining or datamining large-scale failure related data (e.g., historical failure related data). The constructed failure warning model may be imported/updated into the storage device (e.g., into the firmware or NAND of the storage device). Then, the warning module 120 (or the storage device) performs self-warning based on the failure warning model, and subsequently may also transmit failure related data (e.g., failure related new data) to the warning model construction module 110, or the warning model construction module 110 may continuously collect the failure related data. Based on the failure related data, the warning model construction module 110 may continuously optimize or improve and update the failure warning model, and the optimized or improved and updated failure warning model may subsequently be updated into the storage device. Thus, the warning module 120 (or the storage device) may use the updated failure warning model to make increasingly accurate and/or more timely failure warning. The above modules may be implemented by software, hardware, firmware, or various combinations thereof. The failure related data may include monitoring data, failure logs and test data of the storage device, etc.

It should be understood that the failure warning system of the storage device here is only an example and is not limited thereto.

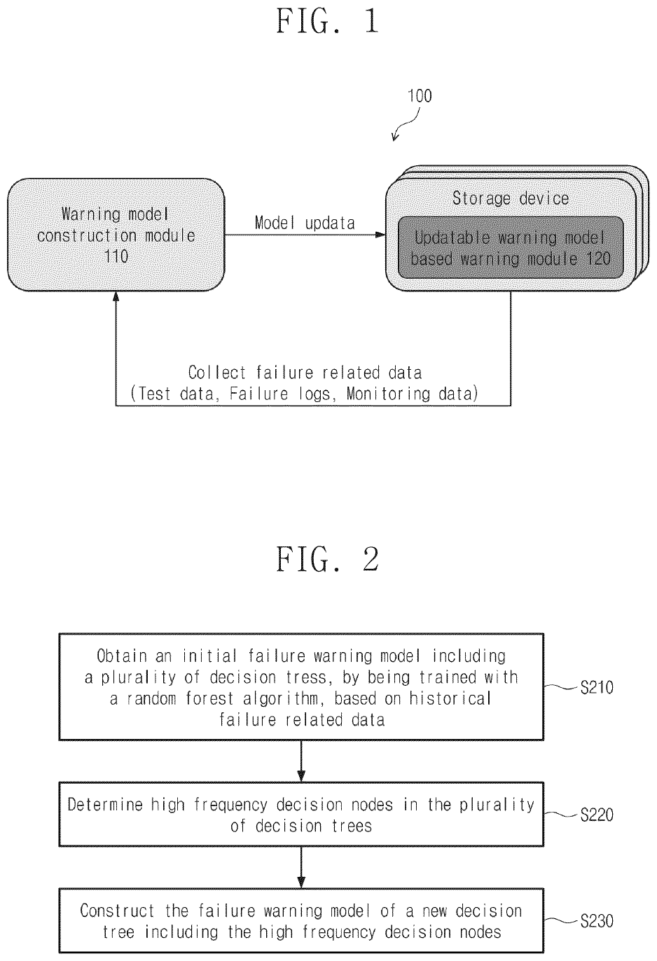

FIG. 2 illustrates a flowchart of a method for constructing a failure warning model of a storage device according to various example embodiments. Here the storage device is, for example, but not limited to, a solid state drive (SSD).

Referring to FIG. 2, in operation S210, an initial failure warning model including a plurality of decision trees is obtained by being trained with a random forest algorithm, based on historical failure related data. The historical failure related data includes historical multiple operational attribute data and failure logs of the storage device.

According to various example embodiments, the multiple operational attribute data may include at least one of the following data: SMART data, Ext-SMART data, Telemetry data. Here, SMART is self-monitoring, analysis and reporting technology, the SMART data and Ext-SMART data may include one or more of status monitoring data of the storage device, Telemetry may be remote data collection from the storage device, and the Telemetry data may include data collected remotely for monitoring storage device performance and failure. The multiple operational attribute data here is only an example and is not limited thereto.

As described herein, for example, the storage device is or includes or is included in an SSD, and for each type of SSD, failure may occur from testing to actual use, and thus generating the historical failure related data. The warning model construction module 110 may continuously collect the historical failure related data generated by the storage device, and as the storage device is used, more and more historical failure related data may be collected. The historical failure related data may also be classified, in terms of type, as storage device failure data and storage device health data, wherein the storage device failure data corresponds to a warning result of storage device failure and the storage device health data corresponds to the warning result of storage device health.

The warning model construction module 110 may construct a training set using the historical failure related data, wherein the training set may include a plurality of training samples, each of which may include a plurality of monitoring attributes of the storage device, and the plurality of monitoring attributes may include, for example, UECC (cannot recover data through ECC error correction), bad_block (bad block), or program_fail (a program write error), etc. For one piece of the historical failure related data, the warning model construction module 110 may extract a plurality of monitoring attributes and a warning result (storage device health or storage device failure) corresponding to this piece of the historical failure related data to construct one training sample, which may include the extracted plurality of monitoring attributes and the corresponding warning result as a label value. For example, one piece of the historical failure related data may be one piece of the multiple operational attribute data (e.g., monitoring data) M₁, which may extract the plurality of monitoring attributes {C₁, C₂, . . . , Cₙ} (wherein n is the number of monitoring attributes), and this piece of the multiple operational attribute data M₁ also corresponds to the warning result R₁. Then, this piece of the multiple operational attributes data may constitute one training sample S₁, e.g. S₁={C₁, C₂, . . . , Cₙ, R₁}. Based on this, the historical failure related data may include pieces of data {M₁, M₂, . . . , Mₘ} (wherein m is the number of pieces of the historical failure related data), and each piece generates a corresponding training sample, which may then form the training set {S₁, S₂, . . . , Sₘ}.

It should be understood that the construction of the training set here is only by example and is not limited thereto.

In some example embodiments, the warning model construction module 110 may construct a decision tree based failure warning model using machine learning or analytical traversal based on the historical failure related data. Specifically, the warning model construction module 110 may construct the training set using the historical failure related data, and construct the decision tree based failure warning model through machine learning or analytical traversal.

In some example embodiments, as to the machine learning methods, the decision tree based failure warning model may be constructed by being trained using the training set based on a decision tree algorithm. Specifically, a multi-attribute decision tree may be generated by being trained based on the decision tree algorithm, and the multi-attribute decision tree, as a decision tree to be pruned (or a decision tree to be trimmed), is subsequently pruned (trimmed).

The decision tree (DT) algorithm constructs the decision tree to discover the classification rules embedded in data, which is essentially the procedure of classifying the data by a set of rules. The warning model construction module 110 may use the constructed training set to generate the multi-attribute decision tree model by being trained based on the decision tree algorithm. The multi-attribute decision tree model generated after being trained typically has many layers of decisions (e.g., greater than 15 layers) with many redundant decisions, and the large multi-attribute decision tree increases the computational complexity and is not conducive to subsequent deployment in the firmware of the storage device. Therefore, redundant decision pruning may be performed on the generated multi-attribute decision tree.

The random forest (RF) algorithm, that is the random forest algorithm making joint decision based on a plurality of decision trees, builds a forest in a randomized manner, and the forest consists of a number of decision trees. After obtaining the forest, when a new input sample enters, each decision tree in the forest makes a separate judgment to see which category the sample should belong to (for classification algorithms), and to see which category is selected the most, then the method may predict that the sample being that category. The random forest may handle both a quantity whose attribute is a discrete value and a quantity whose attribute is a continuous value.

The warning model construction module 110 may obtain, an initial failure warning model including a plurality of decision trees, by being trained with the random forest algorithm based on the historical failure related data. Specifically, the warning model construction module 110 may construct the training set using the historical failure related data, and generate the initial failure warning model with the plurality of decision trees, by being trained with the random forest algorithm based on the constructed training set. Typically, the trained random forest model with the plurality of decision trees (multi-attribute decision trees) have many similar and redundant decision paths, which also increases the computational complexity and is not conducive to subsequent deployment in the firmware of the storage device.

Example embodiments propose key decision path extraction and redundant decision pruning (or redundant decision trimming) applied to the plurality of decision trees generated by the random forest to simplify the model. The key decision path extraction is to determine high frequency decision nodes in the plurality of decision trees generated by being trained and integrate the high frequency decision nodes (removing low frequency decision nodes) as key decision paths to generate a key decision tree.

In operation S220, high frequency decision nodes in the plurality of decision trees are determined. The high-frequency decision nodes may be similar single-nodes with at least a preset number in the plurality of decision trees, and the similar single-nodes may be single-nodes having the same monitoring attribute, the same attribute determination symbol and difference between attribute thresholds within a first range such as a dynamically determined (or, alternatively, a predetermined) range.

The high frequency decision nodes may be the similar single-nodes or similar multi-nodes that occur more often in the plurality of decision trees, wherein the similar multi-nodes may refer to one multi-node having the same number of the similar single-nodes as another multi-node with one-by-one correspondence, that is, each node in similar multi-node is also the similar single-node. Thus, the high frequency decision nodes may be the similar single-nodes with at least a number such as a dynamically determined number (or, alternatively, a preset number) in the plurality of decision trees. The number here may be or be based on a default value (e.g., 3 or 4) and/or an empirical value, which is not limited.

In operation S230, the failure warning model of a new decision tree including the high frequency decision nodes is constructed. After determining the high frequency decision nodes in operation S220, it is also necessary or desirable to integrate the high frequency decision nodes as key decision paths to generate a key decision tree (e.g., a new decision tree). After operation S230, the device may continue to operate, e.g., continue to operate based on the failure warning model of the new decision tree.

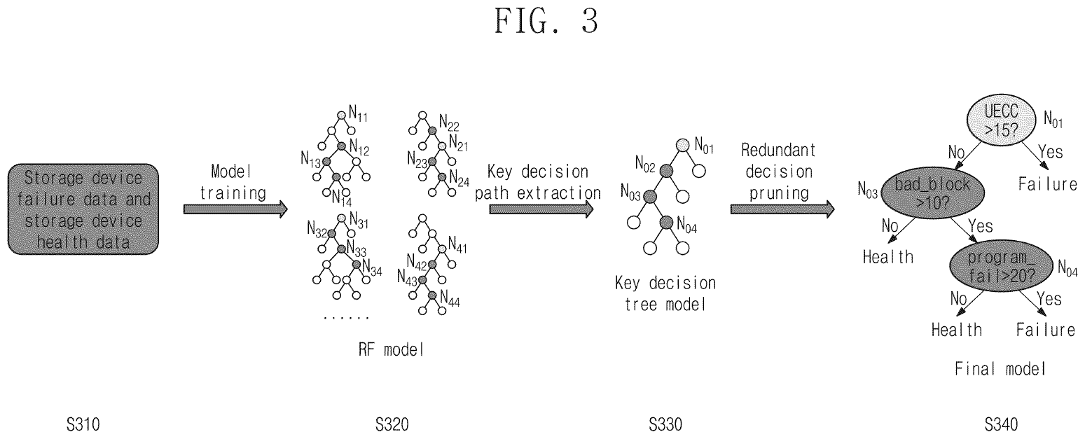

FIG. 3 illustrates a schematic diagram of simplifying a decision tree based failure warning model according to various example embodiments. Referring to FIG. 3, in operation S310, training is performed using the random forest algorithm based on historical failure related data. Specifically, a training set may be constructed using the historical failure related data, and the constructed training set is used as an input for training, wherein the historical failure related data may be classified as storage device failure data and storage device health data. In operation S320, a random forest model including a plurality of decision trees (RF model, e.g., an initial failure warning model) is generated, followed by key decision path extraction; in operation S330, a key decision tree (e.g., a new decision tree) model is generated, followed by redundant decision pruning; and in operation S340, a decision tree based failure warning model (final model) is obtained.

In some example embodiments, the key decision path extraction may be divided into decision path extraction of the similar single-node and decision path extraction of the similar multi-node.

According to various example embodiments, the similar single-nodes in the plurality of decision trees may be categorized into a same single-node group to obtain one or more single-node groups, and the new decision tree may be constructed based on the single-nodes included in the one or more single-node groups.

According to various example embodiments, constructing the new decision tree based on the single-nodes included in the one or more single-node groups may include: determining the number of the single-nodes included in each of the one or more single-node groups, and constructing the new decision tree downward starting from the root node by sequentially selecting the single-nodes from the single-node groups in order of the number of the single-nodes from largest to smallest.

In the decision path extraction of the similar single-node, the similar single-nodes are single-nodes having the same monitoring attribute, the same attribute determination symbol and difference between attribute thresholds within a first range. The monitoring attributes may include, for example, UECC (data cannot be recovered through ECC error correction), bad_block (bad block), or program_fail (a program write error). For example, content of node N₁₁ in the decision tree is “UECC>15”, wherein UECC is the monitoring attribute, “>” is the attribute determination symbol, and 15 is the attribute threshold. For example, if the first range is 20%, the content of similar single-node N₁₂ of node N₁₁ may be “UECC>14”, “UECC>17” or other single-nodes that satisfy the same monitoring attribute (both are UECC) and the same attribute determination symbol (both are “>”) and difference between attribute thresholds within 20%. For another example, if the content of node N₂₁ in the decision tree is “Program_fail>20” and the first range is 20%, then the content of similar single-node N₂₂ of node N₂₁ may be “Program_fail>21” or “Program_fail>22”, etc.

It should be understood that the monitoring attributes, the attribute determination symbols, the attribute thresholds, and the first range here are only examples and are not limited thereto.

In some example embodiments, occurrence frequency of the similar single-node in a plurality of decision trees may be calculated, and the similar single-nodes are extracted in the order of the occurrence frequency of the similar single-node from the highest to the lowest to construct the key decision tree from the root node downward. Specifically, in the process of determining high frequency decision nodes, the similar single-nodes occurring in the plurality of decision trees may be categorized into the same single-node group to obtain one or more single-node groups, e.g., single-node group N₁={N₁₁, N₁₂, N₁₃, . . . , N₁ᵢ} (wherein i is the number of all the similar single-nodes in the plurality of decision trees that may be categorized into this single-node group, e.g., the occurrence frequency of the similar single-node in the plurality of decision trees) or single-node group N₂={N₂₁, N₂₂, . . . , N₂ⱼ} (wherein j is the number of all the similar single-nodes in the plurality of decision trees that may be categorized into this single-node group, e.g., the occurrence frequency of the similar single-node in the plurality of decision trees).

The key decision tree (e.g., a new decision tree) may be constructed based on the single-nodes included in the one or more single-node groups. First, the number of single-nodes included in each of the one or more single-node groups is determined, e.g., i and j. Then, the key decision tree is constructed downward starting from the root node by sequentially selecting single-nodes from the single-node groups in the order of the number of single-nodes from largest to smallest. For example, there are a plurality of single-node groups N₁, N₂, and N₃ sorted according to the number of single-nodes from largest to smallest, then the key decision tree N₁ₚ-N₂ₚ-N₃ₚ is constructed downward starting from the root node by sequentially selecting the single-nodes (e.g., the representative single-nodes) N₁ₚ, N₂ₚ, and N₃ₚ from the plurality of single-node groups N₁, N₂, and N₃. In some example embodiments, the single-node selected from the single-node group (e.g., the representative single-node) may be, for example, a single-node whose attribute threshold is the average or mode value of the attribute thresholds of all the similar single-nodes in the group (with the same monitoring attribute and the same attribute determination symbol as the single-node group), it may also be the single-node with the largest or smallest attribute threshold in the group, or it may be a randomly selected single-node in the group.

Alternatively or additionally, when there are two single-node groups with the same monitoring attribute and the same attribute determination symbol, but with different attribute thresholds, the single-node group with the highest occurrence frequency (e.g., the single-node group with the largest number of single-nodes) in the plurality of decision trees may be selected to participate in the construction of the key decision tree.

Alternatively or additionally, a limit on the number of levels of the constructed key decision tree may be set here (e.g., 10 levels), and only the single-nodes of the 10 single-node groups with the highest occurrence frequency (the largest number of single-nodes) may be selected to constitute the key decision tree. Alternatively or additionally, a low or minimum value of occurrence frequency (minimum value of the number of nodes in the single-node group) may also be set here, and only the single-nodes in the single-node groups whose occurrence frequency is not lower than this minimum value are selected to construct the key decision tree.

It should be understood that the similar single-nodes and the single-node groups here are only examples and are not limited thereto.

According to various example embodiments, similar multi-nodes in the plurality of decision trees may be categorized into the same multi-node group to obtain one or more multi-node groups, and a new decision tree may be constructed based on the multi-nodes included in the one or more multi-node groups. Wherein the similar multi-nodes refer to one multi-node having the same number of similar single-nodes as another multi-node with one-by-one correspondence. Here, the similar single-nodes may be single-nodes having the same monitoring attribute, the same attribute determination symbol and difference between attribute thresholds within a second range such as a second dynamically determined (or, alternatively, a second predetermined) range, which may be the same as or different from the first range.

According to various example embodiments, constructing the new decision tree based on the multi-nodes included in the one or more multi-node groups may include: determining the number of the multi-nodes included in each of the one or more multi-node groups; selecting the multi-nodes in each multiple node group in which the number of the multi-nodes exceeds a number such as a dynamically determined (or, alternatively, a predetermined) number; and constructing the new decision tree in the order of the nodes in which the selected multi-nodes occur most in the plurality of decision trees.

In the decision path extraction of the similar multi-node, the similar multi-nodes refer to (one) multi-node having the same number of the similar single-nodes as another multi-node with one-by-one correspondence, e.g., multi-node P₁={N₁₁, N₁₂, N₁₃} on one decision tree has the same number of the similar single-nodes (all 3) with multi-node P₂={N₂₁, N₂₂, N₂₃} on (the same one or different one) decision tree with one-by-one correspondence. The one-by-one correspondence here does not require that the plurality of similar single-nodes are arranged in the same order in the decision trees. For example, if N₁₁ and N₂₁ are similar single-nodes, N₁₂ and N₂₂ are similar single-nodes and N₁₃ and N₂₃ are similar single-nodes, N₁₁-N₁₂-N₁₃ and N₂₁-N₂₂-N₂₃ are similar multi-nodes, N₁₂-N₁₁-N₁₃ and N₂₁-N₂₂-N₂₃ are similar multi-nodes, N₁₁-N₁₂-N₁₃ and N₂₃-N₂₂-N₂₁ are also similar multi-nodes, That is, as long as one multi-node includes the same number of similar single-nodes, which may be corresponded to, as another multi-node, they are similar multi-nodes. Alternatively, for example, in the case of N₁₁-N₁₂-N₁₃, other nodes may be inserted between N₁₁-N₁₂ as well as N₁₂-N₁₃, that is, as long as three nodes N₁₁, N₁₂, and N₁₃ (wherein N₁₁ and N₂₁ are similar single-nodes, N₁₂ and N₂₂ are similar single-nodes, and N₁₃ and N₂₃ are similar single-nodes) occur in one decision tree, regardless of their order and whether other nodes are inserted there between, they are similar multi-nodes to N₂₁, N₂₂, and N₂₃ in (the same one or different one) decision tree. In the similar multi-node judgment, the concept of similar single-node is also used, but the difference between the attribute thresholds may be appropriately relaxed at this time. That is, the similar single-nodes at this time are single-nodes having the same monitoring attribute, the same attribute determination symbol and difference between attribute thresholds within the second range (the second range may be greater than the first range).

In some example embodiments, occurrence frequency of the similar multi-nodes in a plurality of decision trees may be calculated, and in the case that the occurrence frequency of similar multi-nodes is higher than the frequency, the similar multi-nodes may be extracted, and the key decision tree (e.g., a new decision tree) may be constructed in the order of the nodes in which the extracted similar multi-nodes occur most in the plurality of decision trees. Specifically, in the process of determining high-frequency decision nodes, the similar multi-nodes occurring in the plurality of decision trees may be categorized into the same multi-node group, thereby obtaining one or more multi-node groups, for example, multi-node group {P₁, P₂, . . . , Pₚ}={{N₁₁, N₁₂, N₁₃, N₁₄}, {N₂₁, N₂₂, N₂₃, N₂₄}, . . . , {Nₚ₁, Nₚ₂, Nₚ₃, Nₚ₄}}(wherein P₁, P₂, . . . , Pₚ are similar multi-nodes, and p is the number of the multi-nodes in the multi-node group, e.g., the occurrence frequency of the similar multi-nodes in the plurality of decision trees), and for another example, multi-node group {Q₁, Q₂, . . . , Q_{q}}={{M₁₁, M₁₂, M₁₃}, {M₂₁, M₂₂, M₂₃}, . . . , {M_{q1}, M_{q2}, M_{q3}}} (wherein Q₁, Q₂, . . . , Q_{q} are similar multi-nodes and q is the number of the multi-nodes in the multi-node group, e.g., the occurrence frequency of the similar multi-nodes in the plurality of decision trees).

The key decision tree (e.g., a new decision tree) may be constructed based on the multi-nodes included in the one or more multi-node groups. First, the number of the multi-nodes included in each of the one or more multi-node groups is determined, e.g., p and q. Next, the multi-nodes (e.g., representative multi-nodes) are selected in each multi-node group in which the number of the multi-nodes exceeds a number such as a dynamically determined number or a predetermined number, e.g., if p exceeds the number, the multi-node are selected in multi-node group {P₁, P₂, . . . , Pₚ}. Referring to FIG. 3, for example, the multi-node group {P₁, P₂, . . . , Pₚ} is the multi-node group {P₁, P₂, P₃, P₄} categorized by similar multi-nodes P₁, P₂, P₃ and P₄ occurring in the four decision trees obtained in operation S320 of FIG. 3, at this time, p is 4 greater than the number (e.g., 3). Wherein P₁={N₁₁, N₁₂, N₁₃, N₁₄} is the multi-node in decision tree (1), P₂={N₂₁, N₂₂, N₂₃, N₂₄} is the multi-node in decision tree (2), P₃={N₃₁, N₃₂, N₃₃, N₃₄} is the multi-node in decision tree (3), and P₄={N₄₁, N₄₂, N₄₃, N₄₄} is the multi-node in decision tree (4). Also, N₁₁, N₂₁, N₃₁ and N₄₁ are similar single-nodes, N₁₂, N₂₂, N₃₂ and N₄₂ are similar single-nodes, N₁₃, N₂₃, N₃₃ and N₄₃ are similar single-nodes and N₁₄, N₂₄, N₃₄ and N₄₄ are similar single-nodes. The representative multi-node of a multi-node group may be corresponding multiple representative single-nodes, e.g., the representative multi-node may be {N₀₁, N₀₂, N₀₃, N₀₄}, wherein N₀₁ may be the representative single-node from among the similar single-nodes N₁₁, N₂₁, N₃₁ and N₄₁, that is, the attribute threshold of N₀₁ may be the average or the mode value of the attribute thresholds of the similar single-nodes N₁₁, N₂₁, N₃₁ and N₄₁ (with the same monitoring attribute and the same attribute determination symbol). The attribute threshold of N₀₂ may also be the average or mode value of the attribute thresholds of the similar single-nodes N₁₂, N₂₂, N₃₂ and N₄₂, moreover, N₀₃ and N₀₄ may also be obtained in the same way. Alternatively or additionally, the attribute threshold of N₀₁ may also be or be based on one or more of the maximum, minimum, or randomly selected value of the attribute thresholds of the similar single-nodes N₁₁, N₂₁, N₃₁ and N₄₁ (with the same monitoring attribute and the same attribute determination symbol), and N₀₂, N₀₃, and N₀₄ may also be obtained in the same manner as N₀₁. After selecting the multi-node {N₀₁, N₀₂, N₀₃, N₀₄} (e.g., the representative multi-node) in the multi-node group {P₁, P₂, P₃, P₄}, the key decision tree (e.g., the new decision tree) is constructed in the order of the nodes in which the selected multi-node occur most in the plurality of decision trees. In FIG. 3, the order of the nodes occurring most in the plurality of decision trees is N₀₁-N₀₂-N₀₃-N₀₄, and thus, in operation S330, the decision tree is constructed in the order of N₀₁-N₀₂-N₀₃-N₀₄.

If the above-mentioned p and q both exceed the number (e.g., 2), the selected multi-nodes include, in addition to the representative multi-node {N₀₁, N₀₂, N₀₃, N₀₄} of the above-mentioned multi-node group {P₁, P₂, P₃, P₄}, the representative multi-node {M₀₁, M₀₂, M₀₃} of the multi-node group {Q₁, Q₂, Q₃}, wherein {M₀₁, M₀₂, M₀₃} are determined according to the same (or similar) method of determining the representative multi-node as described above. Then, the key decision tree is constructed in the order of the nodes in which the selected multi-nodes occur most in the plurality of decision trees, for example, the order of the nodes occurring most in the plurality of decision tree is N₀₁-N₀₂-N₀₃-N₀₄-M₀₁-M₀₂-M₀₃ or M₀₁-M₀₂-M₀₃-N₀₁-N₀₂-N₀₃-N₀₄, and there may also be for example N₀₂-N₀₃-M₀₂-M₀₃-N₀₄-M₀₁-N₀₁, then the key decision tree is constructed according to the order of the nodes occurring most as described above.

It should be understood that similar multi-nodes and multi-node groups here are only examples and not limited thereto.

In the random forest algorithm based training, after the key decision tree (e.g., the new decision tree) is constructed, the method may also undergo redundant decision pruning to obtain the decision tree based failure warning model. And after the multi-attribute decision tree is generated by being trained based on the decision tree algorithm, the method may also undergo redundant decision pruning to obtain the decision tree based failure warning model. Here, the key decision tree or the multi-attribute decision tree, as the decision tree to be pruned, may be pruned.

According to various example embodiments, the failure warning model of the new decision tree is pruned to obtain the pruned failure warning model. Examination nodes selected in the new decision tree may be traversed, and for each examination node: obtaining a first warning precision and a second warning precision of the failure warning model before and after removing the examination node, respectively; if the second warning precision is greater than or equal to the first warning precision, removing the examination node from the new decision tree; if the second warning precision is less than the first warning precision, retaining the examination node.

Redundant decision pruning is iteratively eliminating the redundant decisions that have no effect on the decision result to obtain a final simplified decision path. Referring to FIG. 3, the key decision tree (e.g., the new decision tree) in operation S330 is used as the decision tree to be pruned, which includes four nodes N₀₁, N₀₂, N₀₃, N₀₄ from top to bottom except for the leaf nodes, and the node order is N₀₁-N₀₂-N₀₃-N₀₄. After the start of pruning, the examination nodes may be selected one by one in the decision tree to be pruned until all nodes in the decision tree to be pruned are traversed. Here, the examination nodes may be selected in the order of nodes from top to bottom (starting from the root node N₀₁), or in the order of nodes from bottom to top (starting from the node N₀₄), or even in an unordered manner, as long as all the nodes in the decision tree to be pruned are traversed. Then, the first warning precision and the second warning precision of the decision tree to be pruned before and after removing the examination nodes are calculated, respectively.

For example, we select the examination nodes in the order from top to bottom, and N₀₁ is selected as the examination node first. The first warning precision of the decision tree (N₀₁-N₀₂-N₀₃-N₀₄) and the second warning precision of the decision tree (N₀₂-N₀₃-N₀₄) after removing N₀₁ are calculated, respectively. The samples with the same composition (all include a plurality of monitoring attributes and a warning result as a label value) in the training set may be divided into two parts, one part is used as training samples and another part is used as test samples. The warning precision may be calculated by taking the plurality of monitoring attributes in the test samples in the training set as the input of the decision tree, and comparing the label value (the warning result) in the test samples with the output of the decision tree. For example, the warning precision may be the warning accuracy, precision ratio, recall, false positive rate (FPR), false negative rate (FNR) or other evaluation metrics in the field of failure detection and failure identification. In the case that the second warning precision is greater than or equal to the first warning precision, this may indicate that N₀₁ is a redundant node and may be removed to generate the new decision tree (N₀₂-N₀₃-N₀₄) as the decision tree to be pruned. In the case that the second warning precision is less than the first warning precision, this may indicate that N₀₁ is a node that has influence on the decision result, and the current decision tree (N₀₁-N₀₂-N₀₃-N₀₅) is retained as the decision tree to be pruned. Referring to FIG. 3, at this time, the second warning precision is smaller than the first warning precision, and we choose to retain the current decision tree (N₀₁-N₀₂-N₀₃-N₀₄) as the decision tree to be pruned. Since not all the nodes in the decision tree to be pruned have been traversed, a new examination node, such as N₀₂, may be selected for a new round of comparative judgment of the warning precision. That is, the first warning precision of the decision tree (N₀₁-N₀₂-N₀₃-N₀₄) and the second warning precision of the decision tree (N₀₁-N₀₃-N₀₄) after removing N₀₂ are calculated respectively. Referring to FIG. 3, at this time, the second warning precision is greater than or equal to the first warning precision, and N₀₂, which is a redundant node, is removed to generate a new decision tree (N₀₁-N₀₃-N₀₄) as the decision tree to be pruned, and the above procedure is repeated until all nodes in the decision tree to be pruned are traversed. After the traversal calculation is completed, the final decision tree (N₀₁-N₀₃-N₀₄) is obtained as the decision tree based failure warning model, as in operation S340 of FIG. 3.

It should be understood that the decision tree to be pruned and the pruning operations here are only examples and are not limited thereto.

In some example embodiments, as to the method of analytical traversal, a decision tree based failure warning model may be constructed using the training set by analytical traversal. Specifically, a plurality of decision trees may be constructed by traversing different combinations of monitoring attributes, attribute determination symbols and attribute thresholds. The warning precision of each of the plurality of decision trees is calculated. And the decision tree with the highest warning precision is selected among the plurality of decision trees to obtain the decision tree based failure warning model.

In some example embodiments, the warning model construction module 110 may construct a plurality of decision trees by traversing different combinations of monitoring attributes, attribute determination symbols, and attribute thresholds. For example, in the case of including three monitoring attributes {UECC, bad_block, Program_fail}, traversing the combinations of attributes may include: decision trees consisting of or including a single-node {UECC}, {bad_block}, {Program_fail}; decision trees consisting of or including two nodes {UECC, bad_block}, {bad_ block, Program_fail}, {UECC, Program_fail}, wherein the order of the two nodes in the decision trees may be exchanged to form a new decision tree; and decision trees consisting of three nodes {UECC, bad_block, Program_fail}, wherein the order of the three nodes in the decision trees may be exchanged to form a new decision tree. Based on the above traversing the combinations of attributes, the attribute determination symbols (“>” or “<”) and the attribute thresholds may also be traversed. Alternatively or additionally, the traversed attribute thresholds may be or may correspond to a specified range of attribute thresholds, for example, the range of attribute thresholds may be determined based on empirical values or commonly used values. After constructing the plurality of decision trees by traversal, the warning precision of each of the plurality of decision trees is calculated. The warning precision may be calculated by taking the plurality of monitoring attributes in the test samples in the training set as the input of the decision tree, and comparing the label value (the warning result) in the test samples with the output of the decision tree. For example, the warning precision may be the warning accuracy, precision ratio, recall, false positive rate, false negative rate, or other evaluation metrics in the field of failure detection and failure identification. The decision tree with the highest warning precision is selected among the plurality of decision trees to obtain the decision tree based failure warning model. For example, if the decision tree consisting of three nodes (UECC>15)-(bad_block>10)-(Program_fail>20) has the highest warning precision, this decision tree may be used as the decision tree based failure warning model.

It should be understood that the analysis traversal operations here are only examples and are not limited thereto.

Alternatively or additionally, after the decision tree is constructed by analytical traversal, the decision tree constructed by analytical traversal, as the decision tree to be pruned, may be pruned, and the pruning operations may refer to the description about the pruning above and will not be repeated here.

In some example embodiments, failure related new data may be obtained, wherein the failure related new data includes the warning result generated by the storage device using the failure warning model. A decision tree based failure warning model may be constructed based on the failure related new data. The failure related new data is supplemented into the training set, and a new decision tree based failure warning model is constructed using the supplemented training set. A third warning precision of the failure warning model and a fourth warning precision of the new failure warning model are calculated respectively, and an update of the failure warning model is prompted if a difference between the fourth warning precision and the third warning precision is greater than an accuracy threshold.

In some example embodiments, the warning model construction module 110 may continuously acquire the failure related new data. After the warning model construction module 110 has constructed the decision tree based failure warning model, the failure warning model may be imported/updated into the storage device (or the warning module 120), and the storage device may generate the warning result using the failure warning model. The warning model construction module 110 may collect the failure related new data including the warning result generated by the storage device using the failure warning model, supplement the failure related new data into the training set, and use the supplemented training set to construct the new decision tree based failure warning model, thereby continuously optimizing and updating the failure warning model. At the same time, the warning model construction module 110 may also calculate the third warning precision of the failure warning model and the fourth warning precision of the new failure warning model, respectively. The warning precision may be calculated by taking the plurality of monitoring attributes in the test samples in the training set as the input of the decision tree, and comparing the label value (the warning result) in the test samples with the output of the decision tree. For example, the warning precision may be the warning accuracy, precision ratio, recall, false positive rate, false negative rate or other evaluation metrics in the field of failure detection and failure identification. An accuracy threshold, such as a dynamically determined accuracy threshold (or, alternatively, a predetermined accuracy threshold) may be set, and in the case that the difference between the fourth warning precision and the third warning precision is greater than the accuracy threshold, which indicates a significant improvement in the model. At this time, the warning model construction module 110 may prompt an update of the failure warning model. Subsequently, the updated failure warning model (the new failure warning model) may be imported/updated into the storage device.

As described above, the method for constructing the failure warning model of the storage device, in the first aspect, a decision tree based failure warning model is constructed. The more accurate and/or comprehensive decision tree failure warning model is extracted and trained by analyzing failure related data through analytical traversal methods or machine learning methods. Meanwhile, compared with single attribute self-warning, the multi-attribute decision tree failure warning model may introduce read/write related attributes to adapt to different workloads with higher generalizability. In addition, the constructed decision tree failure warning model may be applied to more customers (e.g., customers without large-scale monitoring), and, since there is no centralized data collection, there are no problems such as a long collection interval and data loss during collection. In some example embodiments, the decision tree based failure warning model may be simplified or partially simplified, and its judgment overhead is very small due to the simplification of the decision tree, which is mainly based on the threshold judgment for several attributes. In some example embodiments, the model is optimized and updated by continuously collected the failure related data. Through mining more and more failure related data, more types of failure and symptoms may be discovered, thus the failure model that may warn of more failure is generated.

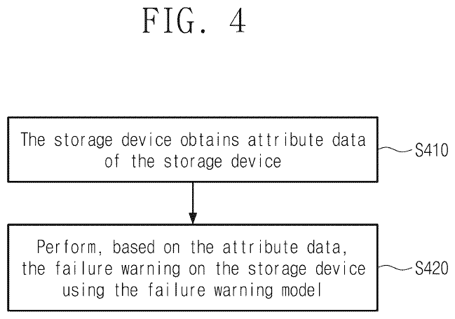

FIG. 4 illustrates a flowchart of a method for failure warning of a storage device according to various example embodiments. Here the storage device is, for example, but not limited to, a solid state drive (SSD).

Referring to FIG. 4, in operation S410, the storage device obtains attribute data of the storage device. In the disclosure, a failure warning model constructed according to the method for constructing the failure warning model of the storage device described above is deployed in the storage device, for example, the failure warning model may be stored in the firmware or NAND of the storage device. The storage device may store the failure warning model in a way of a tree, an array, or otherwise.

According to various example embodiments, the failure warning model may be imported into the storage device. Alternatively, the failure warning model is imported into the storage device through command parameters or a configuration file. The imported failure warning model may be used for real-time failure warning. The storage device may expose a corresponding interface to the user for importing the failure warning model, for example, through an NVMe command. For example, the failure warning model may be imported into the firmware or NAND.

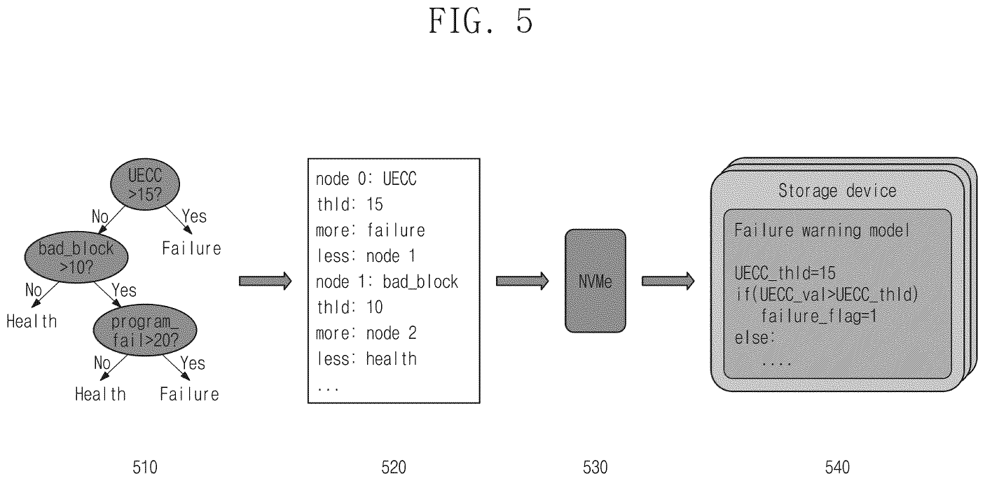

FIG. 5 illustrates a schematic diagram of import/update of a failure warning model into a storage device according to various example embodiments. Here the storage device is, for example, but not limited to, a solid state drive SSD. Referring to FIG. 5, the constructed decision tree based failure warning model (510) may be imported/updated, in the form of the configuration file (520) through an NVMe command (530), into the storage device for storage (540).

In some example embodiments, the attribute data may, for example, include monitoring data, and the storage device may continuously acquire the attribute data, and the attribute data (e.g., monitoring data) may include a plurality of monitoring attributes. Here, the storage device may acquire the attribute data and use the attribute data to construct a data set. The storage device may also directly acquire the data set constructed from the attribute data.

In operation S420, the failure warning is performed on the storage device using the failure warning model based on the attribute data. Here, the storage device uses the attribute data (e.g., the data set constructed from the attribute data) to make frequent decision tree based judgments for the failure warning. For example, the warning module 120 may be deployed in the firmware of the storage device, and the warning module 120 may perform self-warning based on the failure warning model, e.g., the warning module 120 performs the failure warning using (or invoking) the failure warning model stored in the firmware or in the NAND to generate the warning result.

According to various example embodiments, the warning result may include: storage device health and storage device failure. If the warning result is the storage device failure, a failure type of the storage device may be output.

In some example embodiments, when the output result of the failure warning model is storage device failure, the failure may be classified according to the path that the output result takes in the decision tree, so as to output the failure type of the storage device.

According to various example embodiments, the failure warning model stored in the storage device is updated. Alternatively or additionally, the failure warning model stored in the storage device is updated through command parameters or a configuration file. In the disclosure, the failure warning model stored in the storage device may be updated in a timely manner upon receiving an update prompt of the failure warning model from the warning model construction module 110. Similarly, with reference to FIG. 5, the failure warning model stored in the storage device may be updated through exposing the corresponding interface to the user by the aforementioned storage device. For example, the failure warning model may be updated into the firmware or NAND.

As described above, the method for failure warning of the storage device, the warning model is updated into the storage device by command parameters or the configuration file, and the decision tree failure warning model with joint judgment for multiple attributes may make increasingly accurate and timely failure warning through optimization and updating. In addition, construction of the failure warning model is completed outside the storage device, and then the constructed simplified model is imported into the storage device, which fully or nearly fully takes into account the problem of limited computing power of the firmware and facilitates the deployment of the model in the storage device.

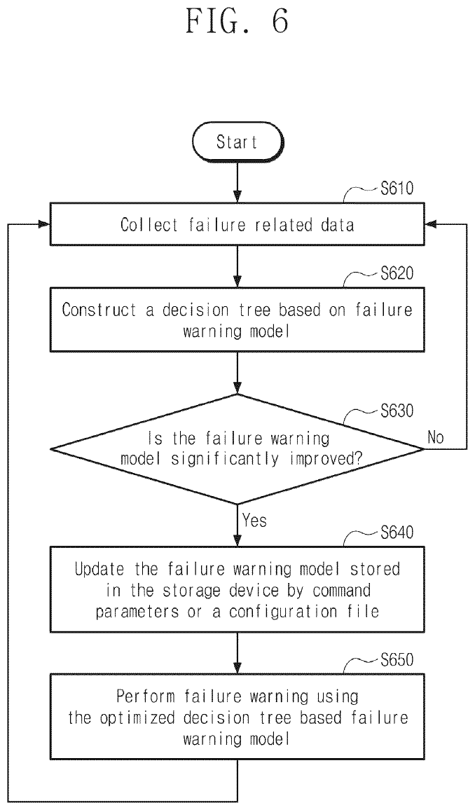

FIG. 6 illustrates an overall flowchart of a method for failure warning of a storage device according to various example embodiments. Here the storage device is, for example, but not limited to, a solid state drive (SSD).

Referring to FIG. 6, in operation S610, failure related data is collected. The warning model construction module 110 may continuously acquire historical failure related data and/or failure related new data.

In operation S620, a decision tree based failure warning model is constructed. The warning model construction module 110 may construct the decision tree based failure warning model based on the failure related data using machine learning (e.g., the random forest algorithm) or analytical traversal.

In operation S630, the failure warning model is significantly improved may be determined. The warning model construction module 110 may continuously acquire failure related new data and supplement the failure related new data into the training set. Then, using the supplemented training set, a new decision tree based failure warning model is constructed. The warning precision of the failure warning model and the warning precision of the new failure warning model are then calculated respectively, and in the case that the difference between the warning precision of the new failure warning model and the warning precision of the failure warning model is greater than an accuracy threshold, the failure warning model may be considered to have been greatly improved and the warning model construction module 110 may prompt an update of the failure warning model. Thus, in the case that the determination is “Yes” in operation S630, the method may proceed to operation S640. In the case that the difference between the warning precision of the new failure warning model and the warning precision of the failure warning model is not greater than the accuracy threshold, that is, in the case that the determination is “No” in operation S630, the method may proceed to operation S610, the failure related data is acquired continually and the model is further optimized or improved.

In operation S640, the failure warning model stored in the storage device is updated by command parameters or a configuration file. Upon receiving an update prompt of the failure warning model from the warning model construction module 110, the failure warning model stored in the storage device may be updated in a timely manner.

In operation S650, failure warning is performed using the optimized decision tree based failure warning model, wherein output warning results is used as the failure related data and the method returns to operation S610 again. The storage device (or the warning module 120) may perform the failure warning using the optimized (updated) failure warning model and output a failure type in the case that the failure warning result is storage device failure. In addition, failure related data including the failure results may be further transmitted to the warning model construction module 110 for further optimization and updating of the model.

Based on experiments with real data, the number of successful warnings is seen to be significantly increased by constructing and updating the decision tree based failure warning model. Thus, the method for failure warning of the storage device may greatly improve the self-warning capability of the storage device, thereby improving the reliability of the storage device.

As described above, the overall flow of the method for failure warning of storage devices extracts or trains a more accurate and comprehensive decision tree based failure warning model by analyzing failure related data through statistical methods or machine learning methods. Due to the simplification of the random forest and decision tree models, which are mainly based on threshold judgment for several attributes, their judgment overhead is very small. By continuously collecting the failure related data to optimize and update the model, and updating the warning model into the storage device through command parameters or the configuration file, the decision tree failure warning model with joint judgment for multiple attributes may make increasingly accurate and timely failure warning through optimization and updating. In addition, construction of the failure warning model is completed outside the storage device, and then the constructed simplified model is imported into the storage device, which fully takes into account the problem of limited computing power of the firmware and facilitates the deployment of the model in the storage device.

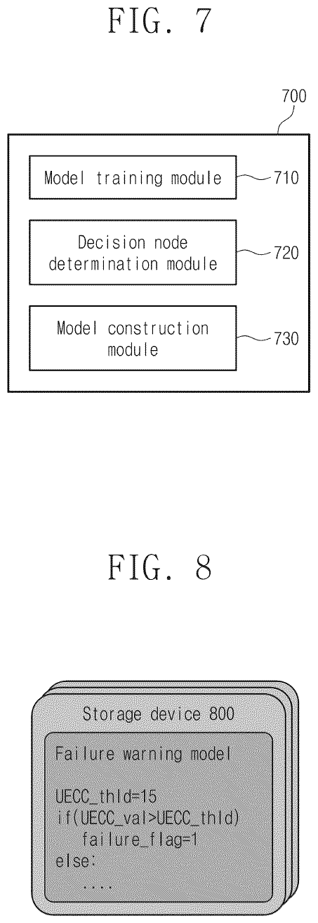

FIG. 7 illustrates a schematic diagram of a device for constructing a failure warning model of a storage device according to various example embodiments. Here the storage device is, for example, but not limited to, a solid state drive (SSD).

Referring to FIG. 7, the device 700 for constructing a failure warning model for a storage device may include a model training module 710, a decision node determination module 720, and a model construction module 730, wherein the model training module 710 may obtain an initial failure warning model including a plurality of decision trees, by being trained with a random forest algorithm based on historical failure related data, the historical failure related data including historical multiple operational attributes data and failure logs of the storage device. The decision node determination module 720 may determine high frequency decision nodes in the plurality of decision trees, the high frequency decision nodes being similar single-nodes with at least a preset number in the plurality of decision trees, the similar single-nodes being single-nodes having the same monitoring attribute, the same attribute determination symbol and difference between attribute thresholds within a first range. The model construction module 730 may construct the failure warning model of a new decision tree including the high frequency decision nodes.

According to various example embodiments, the decision node determination module 720 may categorize similar single-nodes in the plurality of decision trees into a same single-node group to obtain one or more single-node groups; or categorize similar multi-nodes in the plurality of decision trees into the same multi-node group to obtain one or more multi-node groups. Wherein, the similar multi-nodes refer to one multi-node having the same number of similar single-nodes as another multi-node with one-by-one correspondence. The model construction module 730 may construct the new decision tree based on the single-nodes included in the one or more single-node groups or the multi-nodes included in the one or more multi-node groups.

According to various example embodiments, the device 700 for constructing a failure warning model for a storage device 700 may further comprise: a model pruning module 740 (not shown), wherein the model pruning module 740 may prune the failure warning model of the new decision tree to obtain a pruned failure warning model.

According to various example embodiments, the model pruning module 740 may traverse examination nodes selected in the new decision tree, and for each examination node: obtaining a first warning precision and a second warning precision of the failure warning model before and after removing the examination node, respectively; if or in response to the second warning precision being greater than or equal to the first warning precision, removing the examination node from the new decision tree; and if or in response to the second warning precision being less than the first warning precision, retaining the examination node.

According to various example embodiments, the model construction module 730 may determine the number of single-nodes included in each of the one or more single-node groups, and construct the new decision tree downward starting from the root node by sequentially selecting single-nodes from the single-node groups in the order of the number of single-nodes from largest to smallest; or determine the number of the multi-nodes included in each of the one or more multi-node groups, select the multi-nodes in each multi-node group in which the number of the multi-nodes exceeds a number, and construct the new decision tree in the order of the nodes in which the selected multi-nodes occur most in the plurality of decision trees.

According to various example embodiments, the multiple operational attribute data may include at least one of the following data: SMART data, Ext-SMART data, and Telemetry data.

As described above, the device for constructing the failure warning model of the storage device, in the first aspect, the decision tree based failure warning model is constructed. The more accurate and comprehensive decision tree failure warning model is extracted and trained by analyzing failure related data through analytical traversal methods or machine learning methods. Meanwhile, compared with single attribute self-warning, the multi-attribute decision tree failure warning model may introduce read/write related attributes to adapt to different workloads with higher generalizability. In addition, the constructed decision tree failure warning model may be applied to more customers (e.g., customers without large-scale monitoring) and, since there is no centralized data collection, there are no problems such as a long collection interval and data loss during collection. In some example embodiments, the decision tree based failure warning model is simplified, and its judgment overhead is very small due to the simplification of the decision tree, which is mainly based on the threshold judgment for several attributes. In some example embodiments, the model is optimized or improved and updated by continuously collected the failure related data. Through mining more and more failure related data, more types of failure and symptoms may be discovered, thus the failure model that may warn of more failure is generated

FIG. 8 illustrates a schematic diagram of a storage device according to various example embodiments. Here the storage device is, for example, but not limited to, a solid state drive (SSD).

Referring to FIG. 8, the storage device 800 may be deployed with a failure warning model of the storage device obtained by the method for constructing a failure warning model of the storage device as described above. The storage device 800 may obtain attribute data of the storage device, and perform, based on the attribute data, the failure warning on the storage device using the failure warning model.

According to various example embodiments, the storage device 800 may also output a failure type of the storage device if a warning result is storage device failure.

According to various example embodiments, the storage device 800 may further import the failure warning model through command parameters or a configuration file.

As described above, in the storage device according to some example embodiments, the warning model is updated into the storage device by command parameters or the configuration file, and the decision tree failure warning model with joint judgment for multiple attributes may make increasingly accurate and timely failure warning through optimization or improvement and updating. In addition, construction of the failure warning model is completed outside the storage device, and then the constructed simplified model is imported into the storage device, which fully takes into account the problem of limited computing power of the firmware and facilitates the deployment of the model in the storage device.

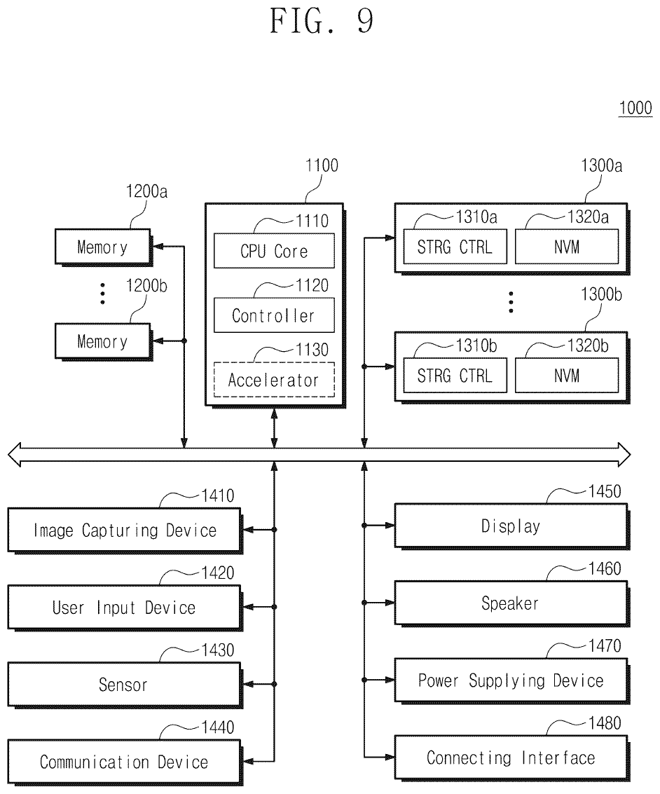

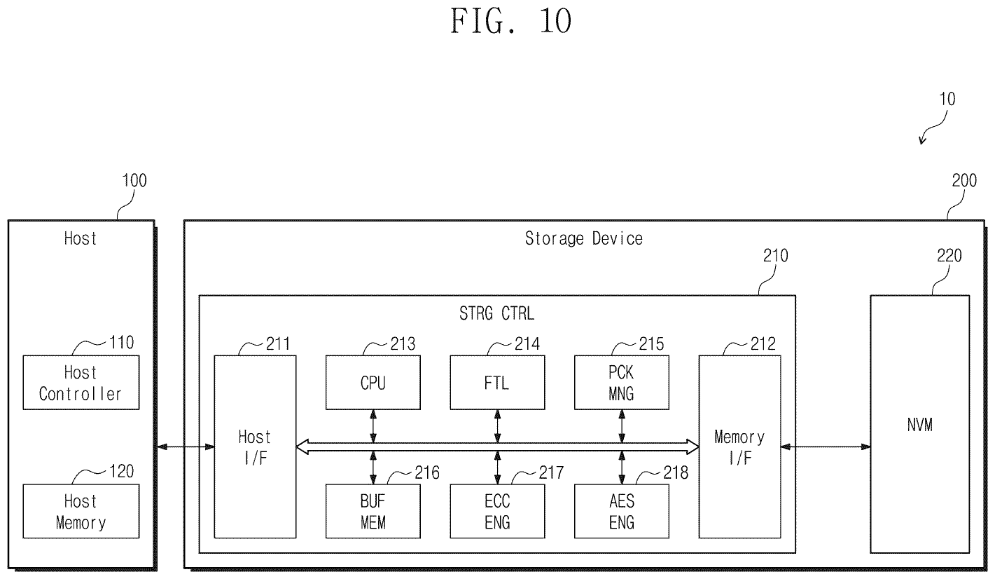

FIG. 9 is a diagram of a system 1000 to which a storage device is applied, according to various example embodiments.

The system 1000 of FIG. 9 may be or may include or be included in one or more of a mobile system, such as a portable communication terminal (e.g., a mobile phone), a smartphone, a tablet personal computer (PC), a wearable device, a healthcare device, or an Internet of things (IOT) device. However, the system 1000 of FIG. 9 is not necessarily limited to the mobile system and may be a PC, a laptop computer, a server, a media player, or an automotive device (e.g., a navigation device).

Referring to FIG. 9, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include one or more of a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using one or more of various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to various example embodiments, a system (e.g., 1000) to which a storage device is applied, is provided, the system includes a main processor (e.g., 1100); a memory (e.g., 1200a and 1200b); and the storage device (e.g., 1300a and 1300b), wherein the storage device is configured to perform the method for failure warning of a storage device as described above.

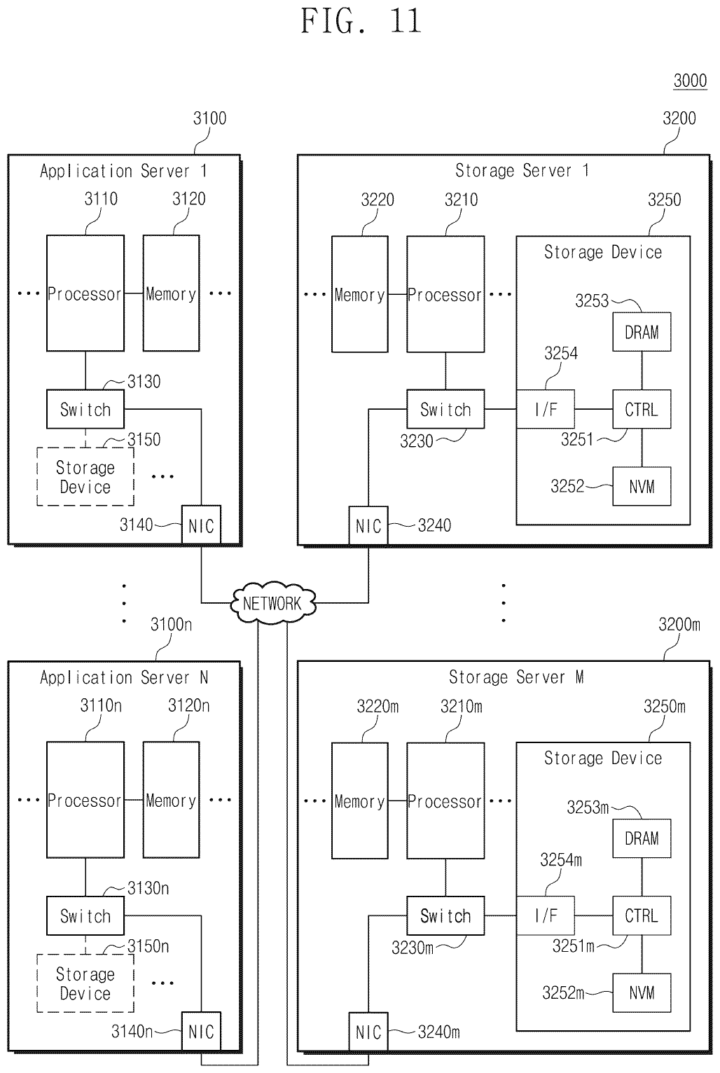

FIG. 10 is a block diagram of a host storage system 10 according to an example embodiment.

The host storage system 10 may include a host 100 and a storage device 200. Further, the storage device 200 may include a storage controller 210 and an NVM 220. According to an example embodiment, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is or includes or is included in an SSD, the storage device 200 may be a device that conforms to an NVMe standard. When the storage device 200 is or includes or is included in an embedded memory and/or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array and/or a 3D (or vertical) NAND (VNAND) memory array. As another example, the storage device 200 may include various other kinds of NVMs. For example, the storage device 200 may include one or more of magnetic RAM (MRAM), spin-transfer torque MRAM, conductive bridging RAM (CBRAM), ferroelectric RAM (FRAM), PRAM, RRAM, and various other kinds of memories.

According to some example embodiments, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to various example embodiments, a host storage system (e.g., 10) is provided, the host storage system includes a host (e.g., 100); and a storage device (200), wherein the storage device is configured to perform the method for failure warning of a storage device as described above.

FIG. 11 is a diagram of a data center 3000 to which a memory device is applied according to some example embodiments.

### Platform Portion—Server (Application/Storage)

Referring to FIG. 11, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In some example embodiments, the processor 3210 and the memory 3220 may provide a processor-memory pair. In some example embodiments, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

### Platform Portion—Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In some example embodiments, the network 3300 may be a storage-dedicated network, such as a storage area network (SAN). For example, the SAN may be or include or be included in an FC-SAN, which uses an FC network and is implemented according to an FC protocol (FCP). As another example, the SAN may be or may include or be included in an Internet protocol (IP)-SAN, which uses a transmission control protocol (TCP)/IP network and is implemented according to a SCSI over TCP/IP or Internet SCSI (iSCSI) protocol. In some example embodiments, the network 3300 may be or include or be included in a general network, such as a TCP/IP network. For example, the network 3300 may be implemented according to a protocol, such as one or more of FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as one or more of ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In some example embodiments, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In some example embodiments, the NIC 3240 may be integrated with at least one of the processor 3210, the switch 3230, and the storage device 3250.

### Organic Relationship—Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In some example embodiments, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to various example embodiments, a data center system (e.g., 3000) is provided, the data center system includes a plurality of application servers (3100 to 3100n); and a plurality of storage servers (e.g., 3200 to 3200m), wherein each storage server includes a storage device, wherein the a storage device is configured to perform any one or more of the methods for failure warning of a storage device as described above.

According to various example embodiments, a computer readable storage medium having a computer program stored thereon is provided, wherein the method for constructing a failure warning model of a storage device or the method for failure warning of a storage device as described above is implemented when the computer program is executed by a processor.

According to various example embodiments, an electronic apparatus is provided, comprising: a processor; and a memory storing a computer program, wherein the computer program when executed by the processor implements the method for constructing a failure warning model of a storage device or the method for failure warning of a storage device as described above.

According to some example embodiments, a non-transitory computer-readable storage medium may also be provided, wherein a computer program is stored thereon. The program when executed may implement the method for constructing a failure warning model of a storage device or the method for failure warning of a storage device according to the disclosure. Examples of non-transitory computer-readable storage media herein include one or more of read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD−R, CD+R, CD−RW, CD+RW, DVD-ROM, DVD−R, DVD+R, DVD−RW, DVD+RW, DVD-RAM, BD-ROM, BD-R, BD-R LTH, BD-RE, Blu-ray or optical disk memory, hard disk drive (HDD), solid state drive (SSD), card-based memory (such as, multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner so as to provide the computer programs and any associated data, data files, and/or data structures to a processor or computer, so that the processor or computer may execute the computer program. The computer program in the computer readable storage medium may run in an environment deployed in a computer device such as one or more of a terminal, client, host, agent, server, etc., and furthermore, in some examples, the computer program and any associated data, data files and/or data structures are distributed on a networked computer system such that the computer program and any associated data, data files and/or data structures are stored, accessed, and/or executed in a distributed manner by one or more processors and/or computers.

Any of the elements and/or functional blocks disclosed above may include or be implemented in processing circuitry such as hardware including logic circuits: a hardware/software combination such as a processor executing software: or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Some example embodiments will readily come to the mind of those of ordinary skill in the art upon consideration of the specification and practice of the inventive concepts disclosed herein. This application is intended to cover any variations, uses, or adaptations that follow the general principles and include commonly known or customary technical means in the art that are not disclosed herein. Variously described embodiments provided in the specification are merely examples, and the scope and spirit is indicated by the following claims. Furthermore example embodiments are not necessarily mutually exclusive with one another. For example, some example embodiments may include one or more features described with reference to one or more figures, and may also include one or more other features described with reference to one or more other figures.

1. A method for operating a storage device, comprising:
obtaining an initial failure warning model comprising a plurality of decision trees, the obtaining the initial failure warning model including being trained with a random forest algorithm based on historical failure related data, the historical failure related data comprising historical multiple operational attributes data of the storage device and failure logs of the storage device;
determining high frequency decision nodes in the plurality of decision trees, the high frequency decision nodes being similar single-nodes with at least a first number in the plurality of decision trees, the similar single-nodes being single-nodes having a same monitoring attribute, a same attribute determination symbol, and a difference between attribute thresholds within a first range; and
constructing a failure warning model of a new decision tree comprising the high frequency decision nodes.

2. The method of claim 1, wherein the determining of the high frequency decision nodes in the plurality of decision trees comprises at least one of:
categorizing the similar single-nodes in the plurality of decision trees into a same single-node group and obtaining one or more single-node groups; or
categorizing similar multi-nodes in the plurality of decision trees into a same multi-node group and obtaining one or more multi-node groups, wherein
the similar multi-nodes refer to one multi-node having a same number of the similar single-nodes as another multi-node with a one-by-one correspondence, and
the constructing of the failure warning model of the new decision tree comprising the high frequency decision nodes comprises constructing the new decision tree based on the single-nodes included in the one or more single-node groups or the multi-nodes included in the one or more multi-node groups.

3. The method of claim 1, further comprising:
pruning the failure warning model of the new decision tree to obtain a pruned failure warning model.

4. The method of claim 3, wherein the pruning of the failure warning model of the new decision tree comprises:
traversing examination nodes selected in the new decision tree, and
for each examination node:
obtaining a first warning precision and a second warning precision of the failure warning model before and after removing the examination node, respectively;
in response to the second warning precision being greater than or equal to the first warning precision, removing the examination node from the new decision tree; and
in response to the second warning precision being less than the first warning precision, retaining the examination node.

5. The method of claim 2, wherein the constructing of the new decision tree based on the single-nodes included in the one or more single-node groups or the multi-nodes included in the one or more multi-node groups comprises:
determining a number of the single-nodes included in each of the one or more single-node groups;
constructing the new decision tree downward starting from a root node by sequentially selecting the single-nodes from the single-node groups in an order of the number of the single-nodes from largest to smallest; or
determining a number of the multi-nodes included in each of the one or more multi-node groups;
selecting the multi-nodes in each multi-node group in which the number of the multi-nodes exceeds a number;
constructing the new decision tree in an order of the nodes in which the selected multi-nodes occur most in the plurality of decision trees.

6. The method of claim 1, wherein the multiple operational attribute data comprises at least one of the following data: SMART data, Ext-SMART data, Telemetry data.

7. A method for failure warning of a storage device, the storage device having deployed therein a failure warning model constructed by the method of 1, wherein the method for failure warning comprises:
the storage device obtaining attribute data of the storage device; and
performing, based on the attribute data, the failure warning on the storage device using the failure warning model.

8. The method of claim 7, wherein in response to a warning result indicating storage device failure, the method for failure warning further comprises:
outputting a failure type of the storage device.

9. The method of claim 7, wherein the method for failure warning further comprises:
importing the failure warning model into the storage device through at least one of command parameters or a configuration file.

10. A device for constructing a failure warning model of a storage device, comprising:
a model training module configured to obtain an initial failure warning model that includes a plurality of decision trees, the obtaining the initial failure warning model including being trained with a random forest algorithm based on historical failure related data, the historical failure related data comprising historical multiple operational attributes data of the storage device and failure logs of the storage device;
a decision node determination module configured to determine high frequency decision nodes in the plurality of decision trees, the high frequency decision nodes being similar single-nodes with at least a number in the plurality of decision trees, the similar single-nodes being single-nodes having a same monitoring attribute, a same attribute determination symbol, and difference between attribute thresholds within a first range; and
a model construction module configured to construct the failure warning model of a new decision tree that includes the high frequency decision nodes.

11. The device of claim 10, wherein the decision node determination module is configured to at least one of:
categorize the similar single-nodes in the plurality of decision trees into a same single-node group and obtain one or more single-node groups; or
categorize similar multi-nodes in the plurality of decision trees into a same multi-node group and obtain one or more multi-node groups, wherein
the similar multi-nodes refer to one multi-node having the same number of the similar single-nodes as another multi-node with one-by-one correspondence, and
the model construction module is configured to construct the new decision tree based on the single-nodes include in the one or more single-node groups or the multi-nodes included in the one or more multi-node groups.

12. The device of claim 10, wherein the device further comprises:
a model pruning module configured to prune the failure warning model of the new decision tree and obtain a pruned failure warning model.

13. The device of claim 12, wherein the model pruning module is configured to:
traverse examination nodes selected in the new decision tree, and for each examination node,
obtaining a first warning precision and a second warning precision of the failure warning model before and after removing the examination node, respectively,
in response to the second warning precision being greater than or equal to the first warning precision, removing the examination node from the new decision tree, and
in response to the second warning precision being less than the first warning precision, retaining the examination node.

14. The device of claim 11, wherein the model construction module is configured to:
determine a number of the single-nodes included in each of the one or more single-node groups;
construct the new decision tree downward starting from a root node by sequentially selecting the single-nodes from the single-node groups in an order of the number of the single-nodes from largest to smallest; or
determine a number of the multi-nodes included in each of the one or more multi-node groups;
select the multi-nodes in each multi-node group in which the number of the multi-nodes exceeds a number;
construct the new decision tree in an order of the nodes in which the selected multi-nodes occur most in the plurality of decision trees.

15. The device of claim 10, wherein the multiple operational attribute data comprises at least one of the following data: SMART data, Ext-SMART data, Telemetry data.

16. A storage device, wherein the storage device has deployed therein a failure warning model constructed by the method of claim 1, the storage device configured to:
obtain attribute data of the storage device; and
perform, based on the attribute data, the failure warning on the storage device using the failure warning model.

17. The storage device of claim 16, wherein in response to a warning result indicating storage device failure,
the storage device is further configured to output a failure type of the storage device.

18. The storage device of claim 16, wherein the storage device is further configured to:
import the failure warning model through command parameters or a configuration file.

19. A system to which a storage device is applied, comprising: a main processor;
a memory; and the storage device; wherein the storage device is configured to perform the method for failure warning of a storage device of claim 7.

20. A host storage system comprising: a host; and a storage device;
wherein the storage device is configured to perform the method for failure warning of a storage device of claim 7.

21-23. (canceled)
